(19) United States
(12) Patent Application Publication
(10) Pub. No.: US 2012/0216779 A1
(43) Pub. Date: Aug. 30, 2012

(54) FUEL SUPPLY DEVICE

(75) Inventors: Takanobu KAWANO, Obu-city (JP); Takumi Kataoka, Okazaki-city (JP); Fukuo Kitagawa, Nukata-gun (JP); Yasuo Kato, Niwa-gun (JP)

(73) Assignees: NIPPON SOKEN, INC., Nishio-city (JP); DENSO CORPORATION, Kariya-city (JP)

(21) Appl. No.: 13/363,710

(22) Filed: Feb. 1, 2012

(30) Foreign Application Priority Data
Feb. 25, 2011 (JP) 2011-39947

(51) Int. Cl. F02M 63/00

(52) U.S. Cl. 123/447

(57) ABSTRACT

A fuel supply device includes: an injector that injects and supplies fuel to an engine; a pressure accumulator communicating with a cylinder of the engine through a communication passage; a valve that opens or closes the communication passage; and a controller that controls the injector and the valve. When the engine is rotated, an air-fuel mixture is compressed in the cylinder, and an accumulating portion of the controller accumulates the air-fuel mixture in the pressure accumulator. When the engine is restarted, a supplying portion of the controller supplies the air-fuel mixture accumulated in the pressure accumulator to the cylinder.

### CROSS REFERENCE TO RELATED APPLICATION

This application is based on Japanese Patent Application No. 2011-39947 filed on Feb. 25, 2011, the disclosure of which is incorporated herein by reference in its entirety.

### BACKGROUND OF THE INVENTION

1. Field of the Invention

The present invention relates to a fuel supply device.

2. Description of Related Art

A vehicle has an idle stop function that an engine of the vehicle is suspended when the vehicle is stopped. The engine is restarted when a brake pedal of the vehicle is released, for example. However, a lot of particulate matters (PM) are contained in the exhaust gas at the engine starting time. The idle stop function may cause an increase in the particulate matters because the number of the engine starting is increased.

In a known art for reducing the particulate matters, a cylinder of the engine is supplied with evaporated fuel which combusts easily at the starting time. The particulate matters are reduced by combusting the evaporated fuel. However, for a vehicle using liquid fuel such as gasoline, it is difficult to make the evaporated fuel stable at the starting time. Further, a compressor such as pump is necessary for pressurizing the fuel so as to supply the evaporated fuel in stable state, so that the above art is difficult to be practiced in real.

No patent document relevant to the present invention was discovered, but JP-A-6-146889 (U.S. Pat. No. 5,603,298) describes an art that a part of the exhaust gas is retained in a pressure accumulator chamber, and that fuel is injected into the pressure accumulator chamber so as to activate the fuel.

### SUMMARY OF THE INVENTION

According to an example of the present invention, a fuel supply device includes an injector that injects and supplies fuel to an engine; a pressure accumulator that accumulates a pressure and communicates with a cylinder of the engine through a communication passage; a valve that opens or closes the communication passage; and a controller that controls the injector and the valve. The controller has an accumulating portion that causes the pressure accumulator to accumulate an air-fuel mixture that is compressed in the cylinder when the engine is rotated, and a supplying portion that causes the air-fuel mixture accumulated in the pressure accumulator to be supplied to the cylinder when the engine is restarted.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view illustrating a fuel supply device according to an embodiment of the present invention;

FIG. 2 is a time chart illustrating an operation of an accumulating portion of a controller of the fuel supply device; and

FIG. 3 is a time chart illustrating an operation of a supplying portion of the controller of the fuel supply device.

### DETAILED DESCRIPTION OF PREFERRED EMBODIMENT

### Embodiment

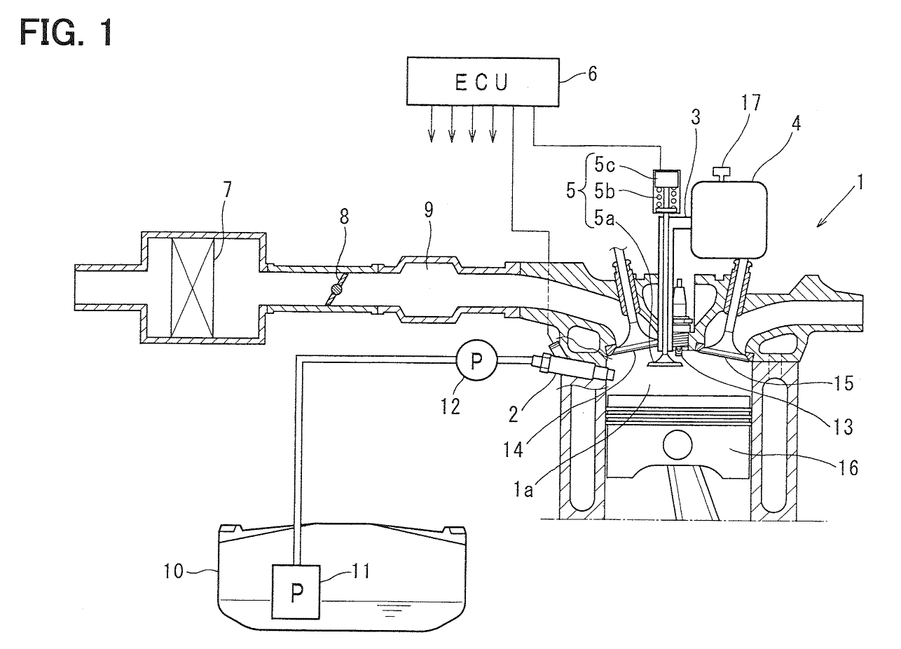

An embodiment of the present invention is explained with reference to FIGS. 1-3. The following embodiment is a concrete example and the present invention is not limited to the embodiment.

As shown in FIG. 1, an engine 1 for a vehicle is a spark-ignition internal combustion engine equipped with plural cylinders. The engine 1 has

(i) an intake passage which draws intake air into each cylinder 1a,

(ii) an exhaust passage which discharges exhaust gas generated in each cylinder 1a into atmospheric air,

(iii) a fuel injection device which injects and supplies fuel into each cylinder 1a, and

(iv) an ignition device which ignites air-fuel mixture compressed in each cylinder 1a.

The intake passage is constructed by an intake pipe, an intake manifold, and an intake port. An air cleaner 7 is arranged in the intake passage, and removes dust contained in the intake air. An intake air sensor (not shown) is arranged in the intake passage, and measures an amount of the intake air. A throttle valve 8 is arranged in the intake passage, and adjusts the amount of the intake air drawn into the cylinder 1a. A surge-tank 9 is arranged in the intake passage, and prevents generation of pulse and interference in the intake air.

The exhaust passage is constructed by an exhaust port, an exhaust manifold, and an exhaust pipe. A catalyst (not shown) which purifies the exhaust air, and a muffler (not shown) for reducing the noise are disposed in the exhaust passage.

The fuel injection device includes a low pressure pump 11, a high pressure pump 12, an injector 2, and an electronic control unit (ECU) 6. The low pressure pump 11 is a fuel feed pump which pumps up liquid fuel (gasoline) stored in a fuel tank 10, and which supplies the fuel to the high pressure pump 12. The high pressure pump 12 pressurizes the fuel to have a predetermined pressure and supplies the fuel to the injector 2.

The injector 2 is a fuel injection valve which is mounted to each cylinder, and performs direct-injection supply of the fuel into each cylinder 1a. Plural branch pipes are branched from the high pressure pump 12 or a fuel accumulator part, and the injector 2 is connected to the respective downstream end of the branch pipe.

The injector 2 has an injection nozzle injecting and supplying the high-pressure fuel into each cylinder 1a, a needle accommodated in the injection nozzle, and an electric actuator such as electromagnetism actuator or piezo actuator performing a lift control of the needle. The injector 2 is a direct injection type one which performs fuel injection directly into each cylinder 1a, for example, but is not limited to the direct injection type one. The injector 2 may perform fuel injection into the intake port.

The ECU 6 has a well-known computer with a control program which computes a target injection quantity and a target injection timing of the fuel according to the operational status of the vehicle. The operational status means an engine parameter such as occupant's operational status, vehicle speed or operational status of the engine 1, for example. Moreover, the ECU 6 controls a drive unit (EDU) which drives the electric actuator of the injector 2. The electric actuator of the injector 2 is controlled through the EDU so that the target injection quantity of the fuel is injected from the injector 2 at the computed target injection timing.

The ignition device ignites the air-fuel mixture compressed in the cylinder 1a, and has an ignition plug 13 and a high voltage generator. The ignition plug 13 is mounted to each cylinder. The high voltage generator impresses high voltage to each ignition plug 13 at a predetermined ignition timing (for example, just before the top dead center in the compression stroke). The high voltage generator may be a distributor of high voltage or a capacitor discharge ignition (CDI), for example. In addition, the ignition device is configured to be able to stop the ignition action of the ignition plug 13 through the control of the ECU 6.

The intake port and the exhaust port are defined in each cylinder head, and an intake valve 14 and an exhaust valve 15 are provided for the intake port and the exhaust port, respectively. The intake valve 14 opens and closes an outlet end of the intake port. The outlet end means a border between the intake port and the cylinder 1a. The exhaust valve 15 opens and closes an inlet end of the exhaust port. The inlet end means a border between the cylinder 1a and the exhaust port.

Each cylinder of the engine 1 successively repeats intake stroke, compression stroke, explosion (expansion) stroke, and exhaust stroke during operation of the engine 1.

In the intake stroke, a volume of the cylinder is increased as a piston 16 is lowered in FIG. 1. The intake valve 14 is opened, and the piston 16 is lowered, so that air is drawn into the cylinder 1a.

In the compression stroke, the volume of the cylinder is decreased as the piston 16 is raised. The piston 16 goes up in a state where the intake valve 14 and the exhaust valve 15 are closed, so that the air-fuel mixture constructed by the air drawn into the cylinder 1a and the fuel injected from the injector 2 is compressed. In addition, the fuel injection timing of the injector 2 is different between a homogeneous combustion and a stratification combustion.

In the expansion stroke, the fuel combustion causes a gas expansion. Therefore, the volume of the cylinder is increased, and the piston 16 is lowered.

In the exhaust stroke, the volume of the cylinder is decreased in accordance with the rise of the piston 16. The exhaust valve 15 is opened, and the piston 16 goes up, so that the exhaust gas is discharged out of the cylinder 1a.

The vehicle of this embodiment has an idle stop function. Specifically, the ECU 6 stops (suspends) the operation of the engine when a predetermined operation state is satisfied, for example, when the vehicle is stopped by stepping the brake pedal. Further, when a predetermined operation state is satisfied while the engine is in the idle stop, for example, when the brake pedal is released, the ECU 6 activates the starter so as to restart the engine 1.

However, a large amount of particulate matters (PM) are contained in the exhaust gas because the mist-state liquid fuel injected from the injector 2 is combusted in the restarting of the engine 1. If the number of the restarting of the engine 1 is increased by the idle stop function, the amount of the particulate matters may be increased.

According to the embodiment, the engine 1 has a pressure accumulator chamber 4, a valve 5 and the ECU 6. The pressure accumulator chamber 4 accumulates a pressure, and communicates with the cylinder 1a of the engine 1 through a communication passage 3. The valve 5 opens or closes the communication passage 3. The ECU 6 controls the operation of the valve 5.

The pressure accumulator chamber 4 may be independently provided for each cylinder, or may be provided in common for the plural cylinders. The pressure accumulator chamber 4 has a volume that can accumulate a predetermined volume of the air-fuel mixture. Specifically, plural (for example, three) times of the combustion can be successively performed at least in each cylinder using the air-fuel mixture supplied from the pressure accumulator chamber 4 to the cylinder 1a in a state where the injection of the injector 2 is stopped.

The valve 5 is a normally-closed valve closing the communication passage 3 when the engine 1 has no load. The valve 5 includes

(i) a valve body 5a which substantially opens and closes the communication passage 3,

(ii) a return spring 5b which biases the valve body 5a in a closing direction, and

(iii) an electric actuator 5c which opens the valve body 5a against the biasing (valve-closing) force of the return spring 5b. For example, the actuator 5c may be an electromagnetism actuator, a piezo actuator or the like.

When the electric actuator 5c is energized, the communication passage 3 is opened so as to connect the pressure accumulator chamber 4 to the cylinder 1a.

The ECU 6 carries out an operation control and an idle stop control of the injector 2, as mentioned above. Further, the ECU 6 controls the electric actuator 5c of the valve 5 according to the operational status of the vehicle.

Specifically, the ECU 6 has a control program corresponding to an accumulating portion and a control program corresponding to a supplying portion. The accumulating portion causes an air-fuel mixture to be compressed in the cylinder 1a and causes the compressed air-fuel mixture to be accumulated in the chamber 4, while the engine 1 is rotated. The supplying portion causes the accumulated air-fuel mixture to be supplied to the cylinder 1a so as to restart the engine 1 when the engine 1 is requested to be restarted after the idle stop.

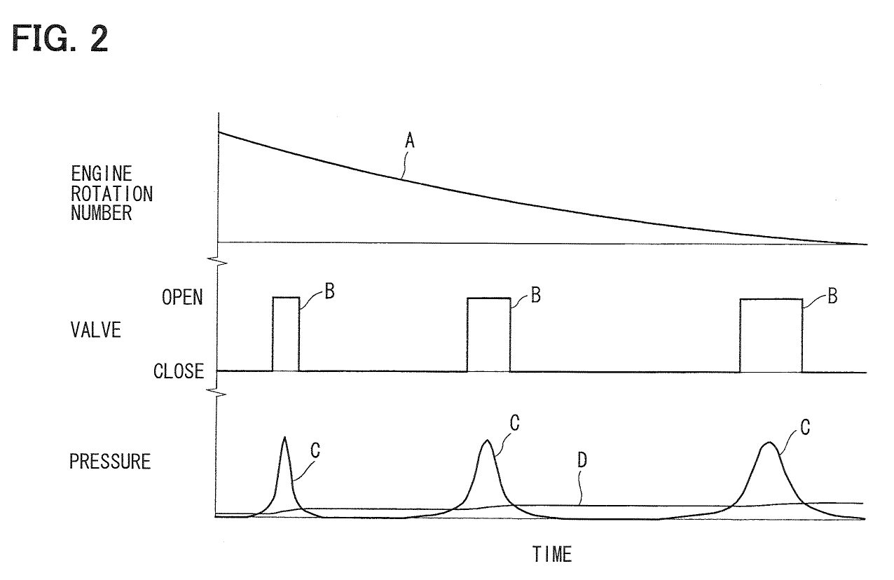

An example of the accumulating portion of the ECU 6 is explained with reference to FIG. 2. In FIG. 2, a continuous line A represents an engine rotation number, a continuous line B represents an opening/closing operation of the valve 5, a continuous line C represents a pressure in the cylinder 1a, and a continuous line D represents a pressure in the pressure accumulator chamber 4.

The ECU 6 activates the accumulating portion when the engine 1 is operated with no load, that is without a fuel combustion, in a state where the pressure is not accumulated in the pressure accumulator chamber 4. If the engine 1 is operated with no load, usually, fuel cut is conducted, for example, when the vehicle has a deceleration operation with the accelerator off.

The accumulating portion stops the ignition action of the ignition plug 13 so as not to ignite the compressed air-fuel mixture, and makes the compressed air-fuel mixture to be accumulated in the pressure accumulator chamber 4. Firstly, in one section from the intake stroke to the compression stroke when the engine 1 is operated with no load, the fuel injection is performed from the injector 2.

Next, the valve 5 is opened at a predetermined crank angle in the compression stroke in which the piston 16 goes up (in the middle of the pressure rising in the cylinder 1a), so that the air-fuel mixture pressurized in the cylinder 1a is introduced into the pressure accumulator chamber 4. Then, the valve 5 is closed at a predetermined crank angle (at which the pressure in the cylinder 1a does not become lower than the pressure in the pressure accumulator chamber 4).

This pressure accumulating operation is repeated a predetermine times (for example, three times in FIG. 2), thereby raising the pressure of the air-fuel mixture in the pressure accumulator chamber 4 to a predetermined pressure. A pressure sensor 17 (see FIG. 1) may detect the internal pressure of the pressure accumulator chamber 4, and the above-mentioned pressure accumulating operation may be repeated until the detection result of the pressure sensor 17 reaches the predetermined pressure.

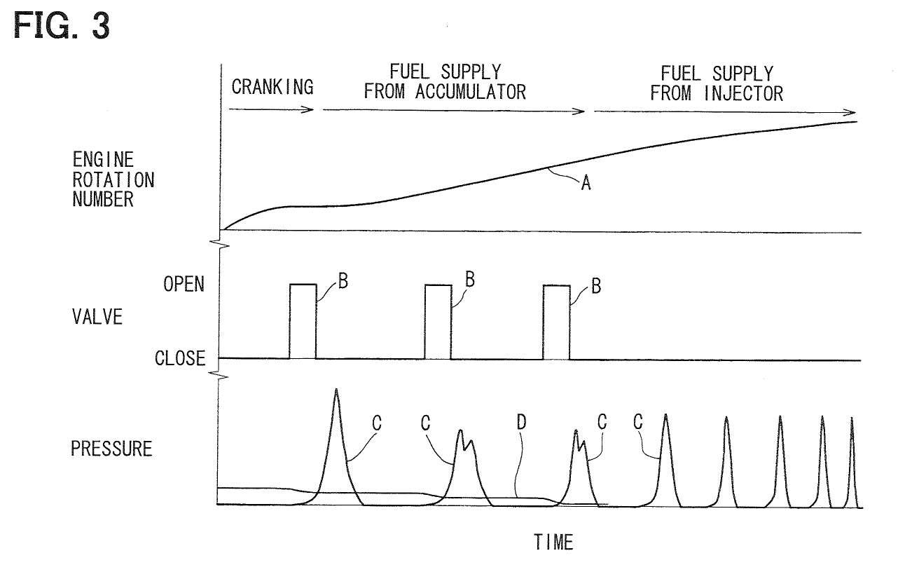

An example of the supplying portion of the ECU 6 is explained with reference to FIG. 3. In FIG. 3, a continuous line A represents an engine rotation number, a continuous line B represents an opening/closing operation of the valve 5, a continuous line C represents a pressure in the cylinder 1a, and a continuous line D represents a pressure in the pressure accumulator chamber 4.

The ECU 6 activates the supplying portion when the engine 1 is restarted in a state where the pressure is accumulated in the chamber 4 and in a state where the engine 1 is in the idle stop state. The state where the pressure is accumulated in the chamber 4 is caused by executing the accumulating portion.

The supplying portion restarts the engine 1 using the air-fuel mixture accumulated in the chamber 4. Specifically, when a cranking of the engine 1 is started by activating the starter, the valve 5 is opened at a crank angle at which the intake valve 14 is closed after the intake stroke, so that the air-fuel mixture accumulated in the chamber 4 is introduced into the cylinder 1a.

Next, the valve 5 is closed at a predetermined crank angle in the compression stroke (before a crank angle at which the pressure in the cylinder 1a and the pressure in the chamber 4 become approximately the same). Thus, an amount of the air-fuel mixture suitable for the restarting is supplied to the cylinder 1a.

Thereafter, when reaching the ignition timing in the compression stroke, the ignition plug 13 ignites the compressed air-fuel mixture, and the air-fuel mixture is exploded in the cylinder 1a.

After the explosion stroke is repeated by a predetermined times (three times in FIG. 3), the operation of the engine 1 is continued by injecting fuel from the injector 2.

A valve-open period of the valve 5 caused by the supplying portion corresponds to a predicted supply amount of the air-fuel mixture supplied from the chamber 4 to the cylinder 1a. The predicted supply amount is an amount of the air-fuel mixture suitable for the restarting. For example, the valve-open period of the valve 5 caused by the supplying portion is set correspondingly to a valve-open number or a valve-open period of the valve 5 at the restarting time.

Alternatively, the internal pressure of the chamber 4 is detected by the pressure sensor 17, and the valve-open period may be calculated by calculating the predicted supply amount from the detection result of the pressure sensor 17.

The fuel supply device includes the injector 2, the pressure accumulator chamber 4, the valve 5 and the ECU 6. The injector injects and supplies the liquid fuel such as gasoline to the engine 1. The accumulator chamber 4 communicates with the cylinder 1a of the engine 1 through the communication passage 3. The valve 5 opens/closes the communication passage 3. The ECU 6 controls the injector 2 and the valve 5.

The ECU 6 has the accumulating portion that causes the air fuel mixture compressed in the cylinder 1a to be accumulated in the chamber 4 by controlling the injector 2 and the valve 5 at the no-load operation time at which no fuel combustion is conducted in the engine 1. The no-load operation time is an example of a condition that the engine is rotated.

The ECU 6 has the supplying portion that causes the accumulated air-fuel mixture to be supplied to the cylinder 1a by stopping the operation of the injector 2 and by controlling the valve 5 when the engine 1 is restarted.

According to the embodiment, when the engine 1 is restarted after the idle stop, the air-fuel mixture accumulated in the pressure accumulator chamber 4 is supplied to the cylinder 1a so as to start the engine 1. The air-fuel mixture accumulated in the pressure accumulator chamber 4 during operation of the engine 1 has high temperature and high pressure, so that the fuel is stable in the gas (evaporated) state. The engine 1 is restarted by using the stable gas fuel, so that the particulate matters (pollutant) can be restricted from being generated at the time of engine restarting. Thereby, even when the restarting of the engine 1 is repeatedly conducted, the particulate matters can be reduced.

According to the embodiment, the air-fuel mixture compressed in the cylinder 1a is accumulated in the pressure accumulator chamber 4. Therefore, the high pressure gas fuel can be supplied to the cylinder 1a without using a pressurizing pump. For this reason, as compared with the conventional technology, the present invention can be carried out easily.

According to the embodiment, when the engine is operated with no load such as decelerating time with the accelerator off, that is when the fuel combustion is not performed, the air-fuel mixture is compressed in the cylinder 1a by controlling the injector 2 and the valve 5, and the compressed air-fuel mixture is accumulated in the pressure accumulator chamber 4. Therefore, the air-fuel mixture compressed during the rotation of the engine 1 with no combustion can be accumulated in the pressure accumulator chamber 4. That is, the air-fuel mixture can be accumulated in the pressure accumulator chamber 4 stably without affecting operation of the engine 1.

According to the embodiment, the pressure accumulator chamber 4 is configured to be heated directly or indirectly with the heat generated by the engine 1. Specifically, the pressure accumulator chamber 4 is arranged so as to directly receive the heat from the engine component such as cylinder head, so as to receive the heat of the exhaust gas, or so as to receive the heat from the engine cooling water or the engine oil. Thereby, the pressure accumulator chamber 4 can be maintained to have the high temperature, and the fuel in the air-fuel mixture accumulated in the pressure accumulator chamber 4 can be stably maintained in the gas state, without being changed into liquid state.

According to the embodiment, the fuel injection of the injector 2 is completely stopped when the supplying portion is operated, that is when the engine 1 is started by supplying the air-fuel mixture accumulated in the chamber 4 to the cylinder 1a. Specifically, as shown in FIG. 3, when the engine 1 is started by activating the supplying portion, the operation of the injector 2 is completely stopped, and the engine 1 is started by only supplying the air-fuel mixture from the chamber 4 to the cylinder 1a. Because no auxiliary injection of the injector 2 is performed at the time of the operation of the supplying portion, the generation of the particulate matters can be suppressed to the minimum level.

However, the present invention is not limited to the above feature. That is, auxiliary injection of the injector 2 may be performed at the time of the operation of the supplying portion so as to raise the pressure in the chamber 4, thereby securing a predetermined air-fuel ratio suitable for the starting. Thus, compared with a case where the restarting is performed by only the injector 2, the particulate matters in the exhaust gas can be reduced even if the injector 2 performs the auxiliary injection, because the ratio of the gas fuel to the air-fuel mixture is high.

According to the embodiment, the engine 1 is a spark-ignition combustion engine using the ignition plug 13. Therefore, the compressed air-fuel mixture can be easily produced in the cylinder 1a by only stopping the operation of the ignition plug 13.

A comparison example is described using a self-ignition combustion engine such as a diesel engine. In the diesel engine, the compressed air-fuel mixture may have self-ignition. Therefore, it is difficult to make the air-fuel mixture at the no-load operation time and to carry out the pressure accumulation in the pressure accumulator chamber 4, in the self-ignition combustion engine.

In contrast, according to the engine 1 of the embodiment, the pressure accumulation of the air-fuel mixture compressed in the cylinder 1a can be easily performed in the pressure accumulator chamber 4.

In the embodiment, the present invention is applied to the restarting of the engine 1 after the idol stop, but is not limited to the idle stop function. For example, the present invention may be applied to a restarting of an engine of a hybrid vehicle in which the engine just stops without the idle stop when the hybrid vehicle is stopped.

In a case where the vehicle is stopped in the state where the air-fuel mixture is accumulated in the pressure accumulator chamber 4, (for example, when the ignition switch of the vehicle is turned off at the destination), the engine 1 gets cold, and the pressure accumulator chamber 4 also gets cold. There is concern that the gas fuel currently stored in the pressure accumulator chamber 4 is changed into liquid state. If the vehicle is predicted to stop (for example, when a navigation system mounted on the vehicle determines that the vehicle approaches the destination), the pressure accumulation operation of the air-fuel mixture may be stopped.

Alternatively, while the engine of the vehicle is stopped, the pressure accumulator chamber 4 may be made to communicate with a particulate filter, and the gas fuel in the pressure accumulator chamber 4 may be adsorbed on the particulate filter.

Alternatively, while the engine of the vehicle is stopped, a bottom part of the pressure accumulator chamber 4 may be made to communicate with the fuel tank 10, and the liquid fuel in the chamber 4 may be returned to the tank 10.

Such changes and modifications are to be understood as being within the scope of the present invention as defined by the appended claims.

What is claimed is:

1. A fuel supply device comprising:
an injector that injects and supplies fuel to an engine;
a pressure accumulator that communicates with a cylinder of the engine through a communication passage and that accumulates pressure;
a valve that opens or closes the communication passage; and
a controller that controls the injector and the valve, wherein the controller has
an accumulating portion that causes the pressure accumulator to accumulate an air-fuel mixture that is compressed in the cylinder when the engine is rotated, and
a supplying portion that causes the air-fuel mixture accumulated in the pressure accumulator to be supplied to the cylinder when the engine is restarted.

2. The fuel supply device according to claim 1, wherein
the accumulating portion causes the air-fuel mixture to be accumulated in the pressure accumulator by controlling the injector and the valve when the engine is operated with no fuel combustion.

3. The fuel supply device according to claim 1, wherein
the pressure accumulator is directly or indirectly heated by heat generated by the engine.

4. The fuel supply device according to claim 1, wherein
the controller completely stops a fuel injection of the injector when the engine is restarted by the supplying portion.

5. The fuel supply device according to claim 1, wherein
the engine is a spark ignition type engine having an ignition plug, and
the air-fuel mixture compressed in the cylinder is ignited by the ignition plug.
